(19) United States
(12) Patent Application Publication
(10) Pub. No.: US 2015/0344370 A1
(43) Pub. Date: Dec. 3, 2015

(54) MATTE FLAME-RETARDANT ARTICLE WITH HIGH TRANSMISSION

(71) Applicants: Karlheinz Hildenbrand, Owingen (DE); Helmut Krülls, Meerbusch (DE); Hans Franssen, Krefeld (DE); Peter Capellen, Krefeld (DE); Rüdiger Hahn, Burscheid (DE); Andreas Müller, Köln (DE); Constantin Schwecke, Alfter (DE)

(72) Inventors: Karlheinz Hildenbrand, Owingen (DE); Helmut Krülls, Meerbusch (DE); Hans Franssen, Krefeld (DE); Peter Capellen, Krefeld (DE); Rüdiger Hahn, Burscheid (DE); Andreas Müller, Köln (DE); Constantin Schwecke, Alfter (DE)

(73) Assignee: Bayer Intellectual Property GmbH, Monheim (DE)

(21) Appl. No.: 14/130,968

(22) PCT Filed: Jul. 4, 2012
(86) PCT No.: PCT/EP2012/062952

§ 371 Date: May 6, 2015

(30) Foreign Application Priority Data
Jul. 8, 2011 (EP) 11173314.3

(51) Int. Cl. C04B 35/14; C04B 35/622

(52) U.S. Cl. CPC C04B 35/14; C04B 35/62222

(57) ABSTRACT

The invention relates to a coated article containing a) a substrate (S) with a transmission of at least 88% (measured according to ASTM E 1348 with 3 mm layer thickness and a wavelength of 550 nm), comprising a substrate layer consisting of a thermoplastic polymer containing a flame-retardant agent, and b) a scratch-resistant coating (K) containing silica micro-particles on the substrate, said coating (K) containing 0.2 to 1.8 wt. %. silica micro-particles relative to the solids content thereof. The invention further relates to the production of such coated articles and the use thereof, especially for producing flat screens.

The invention relates to coated items comprising a substrate (S) made of a transparent thermoplastic polymer comprising flame retardant, and also on one or both sides a scratch-resistant coating (K) comprising silica microparticles. The invention further relates to the production of these coated items and to use of these, in particular for the production of flat screen elements and glazing, and also to flat screen elements and glazing obtainable therefrom.

The expression “screen element” in the present application describes the frontal part of a monitor including what is known as the screen, i.e. a transparent frontal panel for the reproduction of the image, and optionally a peripheral frame made of a preferably nontransparent material. Nowadays, most of the screen elements are flat screen elements.

In recent years there has been strong growth in the market for flat-screen television sets. This growth has been driven not only by advances in flat-screen technology but also in particular by the great emphasis placed by the producers on innovative TV design. It has been possible inter alia to realize innovative designs by using plastics as casing material for TV sets: by way of example, recent years have seen increased incorporation of high-gloss, black front frames in TV sets. Preferred casing parts for use of plastic in recent years have been front frames and reverse sides of TV sets.

Within the interior of the television, one of the challenges is to ensure that as far as possible all of the light generated is emitted forward through the matt panel of the TV set. In this respect, increased requirements have been placed upon the plastics parts in the interior of TV sets in recent years.

The strong growth of the flat-screen television market is accompanied by more stringent safety regulations for these TV sets: EN 60065 prescribes, with reference to CLC/TS 62441 from July 2010, that flat-screen televisions in the European Union must comply with minimum standards for the flame retardancy of the casing materials used. When the requirement for improved flame retardancy is combined with an ever-increasing number of stringent design requirements, there is a resultant need for new approaches to the production of TV-casing parts. One possible option is further modification of the design through increased use of plastics, e.g. in the matt panel, which hitherto has mostly been manufactured from glass, with attention to properties such as transparency, transmittance, and flame retardancy. A possibility that is of great interest for a cost-effective production process is to utilize the same substrate layer for frame and screen of the screen element. The material used therefore has to comply not only with the requirements placed on the frame but also with those placed upon the screen, in particular in respect of abrasion resistance, transmittance, flame retardancy, and viscosity.

For a number of reasons, uncoated substrates do not provide satisfactory compliance with the requirements for use for screen elements, in particular flat screen elements. Firstly, abrasion values are too low, for example with regard to cleaning, and so the level of flame-retardancy properties required for use by way of example in the electrical or electronics sector (E/E) is relatively high and cannot be achieved by many conventional thermoplastic polymers, in particular at low wall thicknesses, if the intention is at the same time to retain a good mechanical property profile. Furthermore, quite a few producers favor surfaces that are matt rather than glossy.

Finally, free-flowing thermoplastics in particular, where these have relatively high MVR values, are of interest for reasons of production technology.

DE 2947 823 A1 and DE 10 2008 010 752 A1 describe scratch-resistant coatings for polycarbonate substrates. Flame retardants are not mentioned.

WO 2008/091131 A1 says that coating compositions made of waterglass, SiO₂, and silanes have a flame-retardant effect, but there is no description of the coated items of the present application.

US 2006/0100359 and JP 2003-128917 describe coating compositions which have a flame-retardant effect. There is no description of the coating of the present application.

The prior art has hitherto not provided any solution which is amenable to simple production and which can satisfy the property profile of a matt and simultaneously flame-retardant item with adequate transmittance, for example the property profile demanded for a use of the screen element of a screen, in the case of items comprising only one substrate layer.

Surprisingly, it has now been found that substrates, for example sheets, panels, or foils, made of flame-retardant transparent thermoplastics have a combination of excellent flame-retardancy properties, matt surface and good transmittance properties after modification with coatings comprising silica microparticles.

The items of the invention, comprising a substrate (S) made of a transparent thermoplastic polymer comprising flame retardant, and also a scratch-resistant coating (K) comprising silica microparticles, therefore provide a solution that is easy to produce and flexible, and that solves the problems described above. It is advantageous that the coatings of the invention can be produced in a single production step, e.g. by the curtain-coating process. In order to prevent scratching, the reverse side of the substrate here can be laminated with a protective foil, for example made of polyethylene.

The curtain-coating process coats not only the frontal side of the substrate but also the edges of the substrate.

The invention therefore provides a coated item comprising a) a substrate (S) with transmittance at least 88% (measured in accordance with ASTM E 1348 at 3 mm layer thickness and wavelength 550 nm) comprising a flame-retardant thermoplastic polymer and b) on the substrate, a scratch-resistant coating (K) comprising silica microparticles, where the amount of silica microparticles present, based on the solids content of the scratch-resistant coating (K), is from 0.2 to 1.8% by weight.

The invention further relates to the production of these items and use of these, in particular for the production of flat screen elements, and for glazing, and also to the flat screen elements and glazing obtainable therefrom.

The items of the invention are highly transparent. For the purposes of this invention, “highly transparent” means that the coated polymer substrate has transmittance of at least 88%, preferably of at least 90%, and very particularly preferably transmittance of from 91% to 92% in the region of the visible spectrum (from 550 to 750 nm), where transmittance is determined in accordance with ASTM E 1348: “Standard Test Method for Transmittance and Color by Spectrophotometry Using Hemispherical Geometry”, and the thickness of the substrate without coating is 3 mm.

For the purposes of the present invention, the expression “silica microparticles” means fully or partially crosslinked silicon dioxide (SiO₂)-based structures with average particle diameter (particle size) from 2 to 15 μm, preferably from 3 to 10 μm, measured by the laser-light-scattering method. The silica microparticles can have been surface-treated (e.g. with wax) or can be unmodified. Preference is given to unmodified (i.e. non-surface-treated) silica microparticles. Silica microparticles are obtainable commercially, an example being Gasil HP 230 from INEOSSilicas Limited with particle size 3.6 μm and with pore volume 1.6 ml/g.

The silica-containing scratch-resistant coatings K involve coatings obtainable from formulations of a scratch-resistant or abrasion-resistant coating material comprising silica microparticles, an example being a silica-containing hybrid coating material, e.g. a siloxane coating material (sol-gel coating material), via flow-coating, dip-coating, spraying, application by roll, or centrifugal application.

For the purposes of the present invention, hybrid coating materials are based on the use of hybrid polymers as binders. Hybrid polymers (Latin “hybrid”: “of dual origin”) are polymeric materials which combine, at a molecular level within themselves, the structural units of various classes of material. By virtue of their structure, hybrid polymers can have entirely novel combinations of properties. A difference from composite materials (defined phase boundaries, weak interactions between the phases) and nanocomposites (use of nanoscale fillers), is that the structural units of hybrid polymers have linkage to one another at a molecular level. This is achieved via chemical processes, e.g. the sol-gel process, which can construct inorganic networks. Use of organically reactive precursors, e.g. organically modified metal alkoxides, can additionally produce organic oligomer/polymer structures. The definition of hybrid coating material also covers acrylate coating materials which comprise surface-modified nanoparticles and which form an organic/inorganic network after curing. There are heat-curable and UV-curable hybrid coating materials.

For the purposes of the present invention, sol-gel coating materials are silicon-containing coating materials which are produced by the sol-gel process. The sol-gel process is a process for the synthesis of nonmetallic inorganic or hybrid-polymeric materials derived from the colloidal dispersions known as sols.

By way of example, these sol-gel coating solutions can be produced via hydrolysis of aqueous dispersions of colloidal silicon dioxide and of an organoalkoxysilane and/or of an alkoxysilane or mixtures of organoalkoxysilanes of the general formula RSi(OR′)₃ and/or alkoxysilanes of the general formula Si(OR′)₄, where R in the organoalkoxysilane(s) of the general formula RSi(OR′)₃ is a monovalent C₁ to C₆ alkyl moiety or is a perfluorinated or partially fluorinated C₁-C₆-alkyl moiety, a vinyl unit or an allyl unit, or an aryl moiety, or is a C₁-C₆ alkoxy group. It is particularly preferable that R is a C₁ to C₄-alkyl group, a methyl, ethyl, n-propyl, isopropyl, tert-butyl, sec-butyl, or n-butyl group, or a vinyl, allyl, phenyl, or substituted phenyl unit. The —OR′ are selected mutually independently from the group consisting of C₁ to C₆-alkoxy groups, a hydroxyl group, a formyl unit, and an acetyl unit. The definition of a hybrid coating material also to some extent covers sol-gel-polysiloxane coating materials.

The colloidal silicon dioxide is obtainable by way of example as, for example, Levasil 200 A (HC Starck), Nalco 1034A (Nalco Chemical Co), Ludox AS-40, or Ludox LS (GRACE Davison). The following compounds may be mentioned by way of example as organoalkoxysilanes: 3,3,3-trifluoropropyltrimethoxysilane, methyl-trimethoxysilane, methyltrihydroxysilane, methyltriethoxysilane, ethyltrimethoxy-silane, methyltriacetoxysilane, ethyltriethoxysilane, phenyltrialkoxysilane (e.g. phenyltriethoxysilane and phenyltrimethoxysilane) and mixtures thereof. The following compounds may be mentioned as examples of alkoxysilanes: tetramethoxysilane and tetraethoxysilane, and mixtures thereof.

Examples of catalysts that can be used are organic and/or inorganic acids or bases.

In one embodiment, the colloidal silicon dioxide particles can also be formed in situ via precondensation starting from akoxysilanes (in which connection see “The Chemistry of Silica”, Ralph K. Iler, John Wiley & Sons, (1979), p. 312-461).

The hydrolysis of the sol-gel solution is terminated or greatly retarded via addition of solvents, preferably alcoholic solvents, e.g. isopropanol, n-butanol, isobutanol, or a mixture thereof. One or more UV absorbers, optionally first dissolved in a solvent, are then added to the sol-gel coating solution, and then an aging step begins, and lasts for a few hours or a number of days/weeks.

It is moreover also possible to add further additives and/or stabilizers, such as leveling agents, surface additives, thickeners, pigments, dyes, curing catalysts, IR absorbers, and/or adhesion promoters. It is also possible to use hexamethyldisilazane or comparable compounds, where these can reduce the susceptibility of the coatings to cracking (cf. also WO 2008/109072 A). It is preferable that the scratch-resistant coating is obtainable from a coating material or sol-gel coating material which respectively comprises no polymeric organosilioxanes. Particularly preferred scratch-resistant coatings are those produced from the abovementioned sol-gel coating solutions. Thermal, UV-stabilized silica-containing sol-gel coating materials are obtainable by way of example from Momentive Performance Materials GmbH, the product names being AS4000® and AS4700®.

A possible heat-curable hybrid coating material is PHC587B® or PHC587C® (Momentive Performance Materials GmbH), in which connection see also EP-A 0 570 165. The layer thickness should be from 1 to 20 μm, preferably from 3 to 16 μm, and particularly preferably from 8 to 14 μm.

Other silica-containing scratch-resistant coatings that are to be used are the UV-curable, silica-nanoparticle-containing acrylate coating materials described in WO 2008/071363 A or DE-A 2804283. A commercially obtainable system is UVHC3000® (Momentive Performance Materials GmbH).

The layer thickness of the scratch-resistant coating is preferably in the range from 1 to 25 μm, particularly preferably from 4 to 16 μm, and very particularly preferably from 8 to 15 μm.

The substrates (S) preferably involve a substrate layer, for example sheets, panels, or foils, or other sheet-like substrates, made of transparent, preferably flame-retardant and/or flame-retardant-containing thermoplastic polymers. The substrate can also be composed of a plurality of these substrate layers. The thermoplastic polymers are preferably those selected from one or more polymers from the group consisting of polycarbonates, copolycarbonates (copolymers comprising polycarbonate units), polyacrylates, in particular polymethyl methacrylate, cycloolefin copolymers, polyesters, in particular polyethylene terephthalate, poly(styrene-co-acrylonitrile), or a mixture of said polymers.

For the purposes of this invention, “transparent” means that the uncoated polymer substrate has transmittance of at least 75%, preferably 80% and very particularly preferably more than 85% in the region of the visible spectrum (from 550 to 750 nm), where transmittance is determined in accordance with ASTM E 1348: “Standard Test Method for Transmittance and Color by Spectrophotometry Using Hemispherical Geometry”, and the thickness of the substrate without coating is 3 mm.

Transparent thermoplastic polymers used are preferably polycarbonate and/or polymethyl methacrylates, or else blends comprising at least one of the two thermoplastics. It is particularly preferable to use polycarbonate. Polycarbonate is a known thermoplastically processable plastic. The polycarbonate plastics are predominantly aromatic polycarbonates based on bisphenols. It is possible to use linear or branched polycarbonates or a mixture of linear and branched polycarbonates, preferably based on bisphenol A. The average molar masses M̅_{w} (weight averages) of the linear and, respectively, branched polycarbonates and copolycarbonates to be used in the items of the invention are generally from 2000 to 200 000 g/mol, preferably from 3000 to 150 000 g/mol, in particular from 5000 to 100 000 g/mol, very particularly preferably from 8000 to 80 000 g/mol, in particular from 12 000 to 70 000 g/mol (determined by means of gel permeation chromatography with polycarbonate calibration).

It is further preferable that within this context the average molar masses of these materials have a weight average M̅w of from 16 000 to 40 000 g/mol.

The MVR (Melt Volume Rate) of the thermoplastic polymer used, in particular polycarbonate, or of the polycarbonate mixture used, is preferably from 10 to 45, preferably from 20 to 40, and particularly preferably from 16 to 36 (for 300° C. and 1.2 kg in accordance with ISO 1133).

For the production of polycarbonates reference may be made by way of example to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally to Dres. U. Grigo, K. Kircher and P. R. Müller “Polycarbonate” [Polycarbonates] in Becker/Braun, Kunststoff-Handbuch [Plastics handbook], Vol. 3/1, Polycarbonate, Polyacetale, Polyester, Celluloseester [Polycarbonates, polyacetals, polyesters, cellulose esters], Carl Hanser Verlag, Munich, Vienna, 1992, pages 117-299. Preference is given to production by the interfacial process or the melt transesterification process.

The polycarbonates have flame-retardant modification via addition of one or more flame-retardant additives.

The thermoplastics can comprise, alongside the flame retardants described at a later stage below, further additives, for example the additives conventional for these thermoplastics, e.g. fillers, UV stabilizers, heat stabilizers, antistatic agents, and pigments in the conventional amounts, and demolding behavior and flow behavior can optionally also be improved via addition of external demolding agents and flow aids (e.g low-molecular-weight carboxylic esters, chalk, powdered quartz, glass fibers and carbon fibers, pigments, and combinations of these). Additives conventionally used for polycarbonate are described by way of example in WO 99/55772, pp. 15-25, EP 1 308 084, and in the corresponding chapters of “Plastics Additives Handbook”, ed. Hans Zweifel, 5^{th} edition 2000, Hanser Publishers, Munich.

For the purposes of the present invention, the substrates (S) can also comprise a plurality of layers made of the abovementioned thermoplastics.

The thermoplastic substrates can be produced from the thermoplastics by way of conventional thermoplastic processing methods, for example by means of single-component or multicomponent injection-molding processes, extrusion, coextrusion, or lamination.

The thickness of the thermoplastic substrates depends on the nature of the application. For a screen element, a conventional thickness is in the range from 1 to 10 mm, preferably from 1 to 5 mm, particularly preferably from 2 to 3 mm. In other applications, thicker or thinner substrates are also used. Substrate thicknesses preferably used for automotive glazing are about 3 mm.

Suitable flame retardants for the purposes of the present invention are inter alia those from the group of the alkali-metal or alkaline-earth-metal salts of aliphatic/aromatic sulfonic-acid, sulfonamide, and sulfonimide derivatives, e.g. potassium perfluoro-butanesulfonate, potassium diphenyl sulfone sulfonate, the potassium salt of N-(p-tolylsulfonyl)-p-toluenesulfimide, and the potassium salt of N-(N′-benzylaminocarbonyl)sulfanylimide.

Examples of salts which can optionally be used in the molding compositions of the invention are: sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzene-sulfate, sodium or potassium methylphosphonate, sodium or potassium 2-phenyl-ethylenephosphonate, sodium or potassium pentachlorobenzoate, sodium or potassium 2,4,6-trichlorobenzoate, sodium or potassium 2,4-dichlorobenzoate, lithium phenylphosphonate, sodium or potassium diphenyl sulfone sulfonate, sodium or potassium 2-formylbenzenesulfonate, sodium or potassium N-benzenesulfonyl-benzenesulfonamide. Trisodium or tripotassium hexafluoroaluminate, disodium or dipotassium hexafluorotitanate, disodium or dipotassium hexafluorosilicate, disodium or dipotassium hexafluorozirconate, sodium or potassium pyrophosphate, sodium or potassium metaphosphate, sodium or potassium tetrafluoroborate, sodium or potassium hexafluorophosphate, sodium or potassium or lithium phosphate, the potassium salt of N-(p-tolylsulfonyl)-p-toluenesulfimide, the potassium salt of N-(N′-benzylaminocarbonyl)sulfanylimide.

Preference is given to sodium or potassium perfluorobutanesulfate, sodium or potassium diphenyl sulfone sulfonate, and sodium or potassium 2,4,6-trichlorobenzoate, and N-(p-tolylsulfonyl)-p-toluenesulfimide potassium salt, the potassium salt of N-(N′-benzylaminocarbonyl)sulfanylimide. Very particular preference is given to potassium nonafluoro-1-butanesulfonate and sodium or potassium diphenyl sulfone sulfonate. Potassium nonafluoro-1-butanesulfonate is obtainable commercially inter alia as Bayowet®C4 (Lanxess, Leverkusen, Germany, CAS No. 29420-49-3), RM64 (Miteni, Italy) or as 3M™ Perfluorobutanesulfonyl FR 2025 (3M, USA). Mixtures of the salts mentioned are likewise suitable.

Amounts used in the molding compositions of these organic flame-retardant salts are from 0.01% by weight to 1.0% by weight, preferably from 0.01% by weight to 0.8% by weight, particularly preferably from 0.01% by weight to 0.6% by weight, based in each case on the entire composition.

Further flame retardants that can be used are by way of example phosphorus-containing flame retardants selected from the groups of the mono- and oligomeric phosphoric and phosphonic esters, phosphonate amines, phosphonates, phosphinates, phosphites, hypophosphites, phosphine oxides, and phosphazenes, and it is also possible here to use, as flame retardants, mixtures of a plurality of components selected from one or more of these groups. It is also possible to use other, preferably halogen-free phosphorus compounds not specifically mentioned here, alone or in any desired combination with other preferably halogen-free phosphorus compounds. This group also includes purely inorganic phosphorus compounds such as boron phosphate hydrate. Phosphonate amines can moreover also be used as phosphorus-containing flame retardants. The production of phosphonate amines is described by way of example in U.S. Pat. No. 5,844,028. Phosphazenes and production thereof are described by way of example in EP-A 728 811 and WO 97/40092. It is also possible to use siloxanes, phosphorylated organosiloxanes, silicones, or siloxysilanes as flame retardants, and this possibility is described in more detail by way of example in EP 1 342 753, DE 10257079A, and EP 1 188 792.

For the purposes of the present invention, phosphorus compounds of the general formula (IV) are preferred

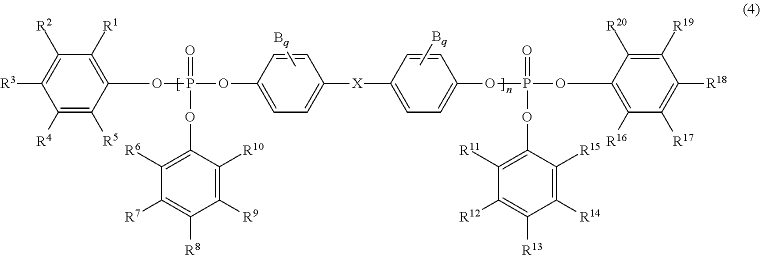

in which
R¹ to R²⁰ are mutually independently hydrogen, or a linear or branched alkyl group having up to 6 C atoms
n is an average value from 0.5 to 50, and
B is respectively C₁-C₁₂-alkyl, preferably methyl, or halogen, preferably chlorine or bromine
q is respectively mutually independently 0, 1, or 2,
X is a single bond, C═O, S, O, SO₂, C(CH₃)₂, C₁-C₅-alkylene, C₂-C₅-alkylidene, C₅-C₆-cycloalkylidene, C₆-C₁₂-arylene, onto which further aromatic optionally heteroatom-containing rings can have been condensed, or a moiety of the formula (5) or (6)

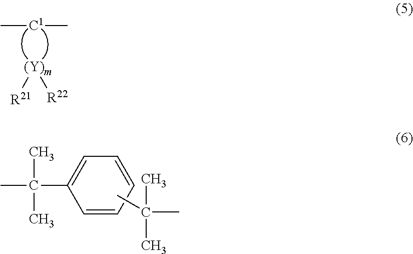

where Y is carbon and
R²¹ and R²² can be selected individually for each Y and are mutually independently hydrogen or C₁-C₆-alkyl, preferably hydrogen, methyl, or ethyl,
m is an integer from 4 to 7, preferably 4 or 5,
with the proviso that on at least one atom Y R²¹ and R²² are simultaneously alkyl.

In particular, preference is given to those phosphorus compounds of the formula (4) in which R1 to R20 are mutually independently hydrogen or a methyl moiety, and in which q=0. In particular, preference is given to compounds in which X is SO₂, O, S, C═O, C₂-C₅-alkylidene, C₅-C₆-cycloalkylidene or C₆-C₁₂-arylene. Very particular preference is given to compounds where X═C(CH₃)₂.

The degree of oligomerization n is calculated as average value from the process for production of the phosphorus-containing compounds listed. The degree of oligomerization n is generally <10 here. Preference is given to compounds where n is from 0.5 to 5.0, particularly from 0.7 to 2.5. Very particular preference is given to compounds which have a particularly high proportion, from 60% to 100%, preferably from 70% to 100%, particularly preferably from 79% to 100%, of molecules where n=1. The above compounds can also comprise, resulting from the production process, small amounts of triphenyl phosphate. The amounts of said substance are mostly below 5% by weight, and in the present context preference is given to compounds having triphenyl phosphate content in the range from 0 to 5 by weight, preferably from 0 to 4% by weight, particularly preferably from 0.0 to 2.5% by weight, based on the compound of the formula (4).

Amounts used of the phosphorus compounds of the formula (4) for the purposes of the present invention are from 1% by weight, to 30% by weight, preferably from 2% by weight, to 20% by weight, particularly preferably from 2% by weight, to 15% by weight, based in each case on the entire composition.

The phosphorus compounds mentioned are known (cf. for example EP-A 363 608, EP-A 640 655) or can be produced analogously in accordance with known methods (e.g. Ullmanns Encyklopädie der technischen Chemie [Ullmann's Encyclopedia of Industrial Chemistry], Vol. 18, pp. 301 ff. 1979; Houben-Weyl, Methoden der organischen Chemie [Methods of Organic Chemistry], Vol. 12/1, p. 43; Beilstein Vol. 6, p. 177).

For the purposes of the present invention, particular preference is given to bisphenol A diphosphate. Bisphenol A disphosphate is obtainable commercially inter alia as Reofos® BAPP (Chemtura, Indianapolis, USA), NcendX® P-30 (Albemarle, Baton Rouge, La., USA), Fyrolflex® BDP (Akzo Nobel, Arnheim, Netherlands), or CR 741® (Daihachi, Osaka, Japan).

The production of said flame retardants is also described by way of example in US-A 2002/0038044.

Other phosphoric esters which can be used for the purposes of the present invention are moreover triphenyl phosphate, which is supplied inter alia as Reofos® TPP (Chemtura), Fyrolfiex® TPP (Akzo Nobel), or Disflamoll® TP (Lanxess), and resorcinol diphosphate. Resorcoinol diphosphate can be purchased as Reofos RDP (Chemtura) or Fyrolfiex® RDP (Akzo Nobel).

Other suitable flame retardants for the purposes of the present invention are halogen-containing compounds. Among these are brominated compounds such as brominated oligocarbonate (e.g. tetrabromobisphenol A oligocarbonate BC-52®, BC-58®, BC-52HP® from Chemtura, polypentabromobenzyl acrylates (e.g. FR 1025 from Dead Sea Bromine (DSB)), oligomeric reaction products of tetrabromobisphenol A with expoxides (e.g. FR 2300 and 2400 from DSB), or brominated oligo- or polystyrenes (e.g. Pyro-Chek® 68PB from Ferro Corporation, PDBS 80 and Firemaster® PBS-64HW from Chemtura).

For the purposes of this invention, particular preference is given to brominated oligocarbonates based on bisphenol A, in particular to tetrabromobisphenol A oligocarbonate.

Amounts used of bromine-containing compounds for the purposes of the present invention are from 0.1% by weight to 30.0% by weight, preferably from 0.1% by weight to 20.0% by weight, particularly preferably from 0.1% by weight to 10.0% by weight, and very particularly preferably from 0.1% by weight to 5.0% by weight, based in each case on the entire composition.

The thermoplastic polymers for the polymer substrates can also respectively receive additions of additives conventionally used for said thermoplastics, for example fillers, UV stabilizers, heat stabilizers, antistatic agents, and pigments, in the usual amounts; it is also optionally possible to influence demolding behavior, and/or other properties via addition of external demolding agents, flow agents, and/or other additives. Compounds suitable as additives are described by way of example in WO 99/55772, pp. 15-25 and EP 1 308 084, and in the corresponding chapters of “Plastics Additives Handbook”, ed. Hans Zweifel, 5^{th} edition 2000, Hanser Publishers, Munich.

Flame-retardant polycarbonates of the invention are obtainable commercially by way of example from Bayer MaterialScience, Leverkusen as Makrolon® 6001, Makrolon® 6557; Makrolon® 6555, or Makrolon® 6485.

The coated items of the invention have excellent flame retardancy properties in combination with a matt surface and good transmittance and very good abrasion resistance. No “rainbow effects” are observable at layer thicknesses greater than 10 μm. In particularly preferred embodiments the material for the polymer substrates is composed of flame-retardant polycarbonate which has melt viscosity values (Melt Volume Rate MVR in cm³/10 min)>9 (for 300° C. and 1.2 kg in accordance with ISO 1133), particularly preferably MVR>20 (for 300° C. and 1.2 kg in accordance with ISO 1133), and very particularly preferably MVR>30 (for 300° C. and 1.2 kg in accordance with ISO 1133).

Flame retardancy properties can be determined by way of example by one or more of the following flame retardancy tests:

The flame retardancy of plastics is commonly determined by method UL 94 V of Underwriters Laboratories Inc. Standard of Safety, “Test for Flammability of Plastic Materials for Parts in Devices and Appliances”, pp. 14 ff, Northbrook 1998; J. Troitzsch, “International Plastics Flammability Handbook”, pp. 346 ff., Hanser Verlag, Munich 1990. These procedures evaluate afterflame times and flaming-drop behavior of standard ASTM specimens.

For classification of a flame-retardant plastic into fire class UL 94 V-0, compliance with the following detailed criteria is required: afterflame times for all of the specimens in a set of 5 standard ASTM test specimens (dimensions: 127×12.7×X, where X=thickness of test specimen, e.g. 3.2; 3.0; 1.5; 1.0, or 0.75 mm) after two flame applications of duration 10 seconds using an open flame of defined height must be no longer than 10 seconds.

The sum of the afterflame times for 10 flame applications to 5 specimens must be no greater than 50 seconds. Other phenomena not permitted are: flaming drops, combustion of the entire specimen, and afterglow time longer than 30 seconds for any test specimen. The UL 94 V-1 classification requires that the individual afterflame times are not longer than 30 seconds and that the sum of the afterflame times for 10 flame applications to 5 specimens is not greater than 250 seconds. Total afterglow time must not be more than 250 seconds. The other criteria are identical with the abovementioned. Classification into fireclass UL 94 V-2 takes place when flaming drops occur but there is compliance with the other criteria of UL 94 V-1.

The combustibility of test specimens can moreover also be assessed via determination of the oxygen index (LOI in accordance with ASTM D2863-77).

Another flame retardancy test is the glow-wire test in accordance with DIN IEC 695-2-1. Here, a glowing wire is used at temperatures of from 550 to 960° C. on three test specimens in succession (for example on plaques of geometry 60×60×2 mm or 1 mm) to determine the maximal temperature at which an afterflame time of 30 seconds is not exceeded and the specimen does not produce flaming drops. This test is of particular interest in the electrical/electronics sector, since a defect or overload can cause components in electronic products to assume high temperatures such that parts in the immediate vicinity can ignite. This type of thermal stress forms the basis for the glow-wire test.

In one specific form of the glow-wire test, the glow-wire ignition test in accordance with IEC 60695-1-13, the main issue is the ignition behavior of the test specimen. Here, the specimen is not permitted to ignite during the test procedure, the definition of ignition here being appearance of a flame for longer than 5 seconds. The specimen is not permitted to produce any flaming drops.

The items of the invention pass one or more of the abovementioned flame retardancy tests and moreover have other advantageous properties, in particular in relation to scratch resistance and to abrasion resistance, transmittance/transparency, and rainbow effects.

The coated items are highly transparent. In particular, their transmittance at 3 mm layer thickness and at wavelength 550 nm is at least 88%, preferably more than 89%, and in very particularly preferred cases more than 89.5%, or more than 90%, and at wavelength 700 nm at least 90%, preferably more than 91%, and in very particularly preferred cases more than 91.5%, or more than 92%.

The coated items also have good abrasion resistance values, and increased flame retardancy values, in combination with said transparency.

In respect of abrasion resistance, values obtained in accordance with the abrasion test (DIN 53 754) at 1000 revolutions of the abrasion wheels are less than 15% haze (Δ haze₁₀₀₀), in particular less than 10%, and very particularly less than 5%.

In respect of flame retardancy based on the UL 94 V standard, at least 70% of the individual specimens are evaluated as V-1—or better, and it is preferable that 80% of the specimens are evaluated as V-1—or better, and it is particularly preferable that 90% of the specimens are evaluated as V-1—or better, and it is very particularly preferable that 100% of the specimens are evaluated as V-1—or better.

The item of the invention is therefore characterized in that its transmittance in accordance with ASTM E 1348 at wavelength 550 nm is at least 88%, preferably more than 89%, and in very particularly preferred cases more than 89.5%, or more than 90%, and at wavelength 700 nm at least 90%, preferably more than 91%; its values exhibited in the abrasion test, measured in accordance with DIN 53 754 are less than 15% haze (Δ haze₁₀₀₀), in particular less than 10%, and very particularly less than 5%, and in flame retardancy tests being in accordance with the UL 94 V standard there is 70% probability that it is evaluated as V1—or better, in particular 80% probability that is evaluated as V1—or better, particularly preferably 90% probability that it is evaluated as V1—or better, and very particularly preferably 100% probability that it is evaluated as V1—or better.

The items of the invention can therefore by way of example be used for the cost-effective production of flat screen elements, where frame and screen can optionally be produced in a single injection-molding process. The invention can moreover also be utilized for other glazing applications, for example architectural glazing and automotive glazing.

### EXAMPLES

### A) The Substrates

### Example 1

### Production of a Flame-Retardant Polycarbonate with High MVR Value

The following thermoplastic polymers were used for the production of the composition used in examples 6 to 10:

Makrolon® 2408 is a bisphenol-A-based polycarbonate obtainable commercially from Bayer MaterialScience AG. Makrolon® 2408 is EU/FDA-approved and comprises no UV absorber. Melt volume flow rate (MVR) in accordance with ISO 1133 is 19 cm³/(10 min) for 300° C. and 1.2 kg load.

Makrolon® LED2245 is a linear bisphenol-A-based polycarbonate obtainable commercially from Bayer MaterialScience AG. Makrolon® LED2245 is EU/FDA-approved and comprises no UV absorber. Melt volume flow rate (MVR) in accordance with ISO 1133 is 35 cm³/(10 min) for 300° C. and 1.2 kg load.

The following additives were used:

“C4”=Bayowet® C4 is a potassium nonafluoro-1-butanesulfonate obtainable commercially from Lanxess AG.

The flame-retardant thermoplastic compositions of the present invention are compounded in an apparatus comprising a) metering equipment for the components, b) a corotating twin-screw kneader (ZSK 25 from Werner & Pfleiderer) with screw diameter 25 mm c) a pelletizing die for the shaping of melt strands d) a waterbath for the cooling and the solidification of the strands, and a pelletizer.

The thermoplastic polymer composition for the substrate in examples 6 to 10 was produced by metering 10% by weight of a powder mixture made of 99.35% by weight of pulverulent Makrolon® 2408 with 0.65% by weight of flame retardant C4 into 90% by weight of Makrolon LED® 2245 pellets.

The process parameters set here were as follows:

| Process parameter | | |
|---|---|---|
| Melt temperature | 272° | C. |
| Rotation rate of extruder | 99 | min⁻¹ |
| Torque in % | 37-45% | |
| Die pressure | 19 | bar |
| Holes in die | 1 × 4 | mm |
| Temperature of barrel section 1: | 54° | C. |
| Temperature of barrel section 2: | 220° | C. |
| Temperature of barrel section 3: | 240° | C. |
| Temperature of barrel section 4: | 260° | C. |
| Temperature of barrel section 5: | 260° | C. |
| Temperature of barrel section 6: | 260° | C. |
| Temperature of barrel section 7: | 260° | C. |
| Temperature of barrel section 8: | 260° | C. |
| Temperature of head 13: | 260° | C. |

A free-flowing bisphenol A polycarbonate was obtained with MVR 36 cm³/10 min (300° C./1.2 kg) (measured in accordance with ISO 1133) (substrate).

### Example 2

### Production of a Flame-Retardant Polycarbonate with Low MVR Value

Plaques made of Makrolon® 6555 (bisphenol A polycarbonate from Bayer MaterialScience AG, medium viscosity: MVR (300° C./1.2 kg) 10 cm³/10 min, equipped with chlorine- and bromine free flame retardant) were produced by processing the respective pellets to give test specimens in the form of plaques of geometry 100*150*2 mm and 100*150*3 mm. This is achieved by using an Arburg Allrounder 270S-500-60 with screw diameter 18 mm. The process parameters set here are as follows:

| Process parameter | | |
|---|---|---|
| Melt temperature | 300° | C. |
| Mold temperature | 90° | C. |
| Injection velocity | 40 | mm/s |
| Backpressure | 150 | bar |

### Example 3

### Plaques Made of the Composition of Example 6

By analogy with example 2, plaques were produced from the bisphenol A polycarbonate, MVR (300° C./1.2 kg in accordance with ISO 1133) 35 cm³/10 min, equipped with bromine-free flame retardant of example 1.

| Process parameter | | |
|---|---|---|
| Melt temperature | 280° | C. |
| Mold temperature | 90° | C. |
| Injection velocity | 40 | mm/s |
| Backpressure | 150 | bar |

### Example 4

### UL Test Specimens Made of Makrolon® 6555

UL test specimens of various thicknesses were injection-molded by using the same injection-molding machine (Arburg Allrounder 270S-500-60 with screw diameter 18 mm) and process parameters the same as those in example 2: test specimen dimensions: 127 mm*12.7 mm*D mm (D (mm)=3.2/2.6/2.2, and also 2.0) made of Makrolon® 6555 (bisphenol A polycarbonate from Bayer MaterialScience AG, medium viscosity: MVR (300° C./1.2 kg in accordance with ISO 1133) 10 cm³/10 min, equipped with chlorine- and bromine free flame retardant).

The UL test specimens are standard ASTM test specimens for UL 94 fire classification.

### Example 5

### UL Test Specimens Made of the Composition of Example 1

By analogy with example 3, UL test specimens were produced from the bisphenol A polycarbonate, MVR (300° C./1.2 kg), 36 cm³/10 min, equipped with bromine-free flame retardant, of example 1.

### B) Production and Testing of the Coated Items

### a) Scratch-Resistant Coating Materials Used

PHC587 is obtainable commercially from Momentive Performance Materials GmbH, Germany, and is a weathering-resistant and abrasion-resistant silica-containing scratch-resistant-coating-material formulation with organic constituents with 20+/−1% by weight solids content of silica in a solvent mixture of methanol, n-butanol, and isopropanol.

The scratch-resistant coating material can be coated onto polycarbonate substrates without any intermediate primer layer. In the examples described here, the coating was achieved by means of immersion.

After coating, the material was conditioned (curing process) for 60 min. in a hot-air oven at 130° C.

### b) Test Methods:

Haze: Haze is determined by way of wide-angle light scattering in accordance with ASTM D 1003. The data are given in % haze (H), and low values here (e.g. 0.5% H) mean low haze and high transparency.

Steel wool test: The test equipment used for the test was an “Abraser” from Byk Gardner, and Rakso type 00 steel wool was used here with an applied weight of 150 g. The total number of forward and reverse movements executed was 20, and scratching was assessed visually here.

Transmittance test: Equipment: Perkin Elmer Lamda 900, total transmittance being measured

Fire behavior is measured in accordance with UL 94V on specimens measuring 127×12.7×3.0 mm.

### Example 6

Coating of flame-retardant Makrolon® LED 2245 plaques with the single-layer coating material PHC 587®

Substrate: Makrolon® LED 2245/C4 plaque, as described in A)

Coating material: PHC 587 (20% in organic solvent), as described under B)

Application of coating material: The substrate, provided with a protective foil on the reverse side, is coated by immersion into the PHC 587 coating material. Some of the solvent is then allowed to evaporate during 30 minutes at room temperature. After removal of the protective foil, the material is conditioned at 130° C. for 60 minutes, whereupon a scratch-resistant, transparent coating of thickness about 5 μm is obtained on the frontal side and the edges.

The results are shown in summary in table 1.

### Example 7

Coating of flame-retardant Makrolon® LED 2245 plaques with the single-layer coating material PHC 587 which comprises 0.4% by weight of Gasil HP 230 matting agent

Substrate: LED 2245/C4 plaque, as described in A)

Coating material: 0.4 g of Gasil HP 230 is stirred into 500 g of PHC 587 coating material. A filter with pore size from 3 to 5 μm is then used for filtration.

Application of coating material: By analogy with example 6.

The results are shown in summary in table 1.

### Example 8

Coating of flame-retardant Makrolon® LED 2245 plaques with the single-layer coating material PHC 587 which comprises 0.75% by weight of Gasil HP 230 matting agent

Substrate: LED 2245/C4 plaque, as described in A)

Coating material: 0.75 g of Gasil HP 230 is stirred into 500 g of PHC 587 coating material. A filter with pore size from 3 to 5 μm is then used for filtration.

Application of coating material: By analogy with example 6.

The results are shown in summary in table 1.

### Example 9

Coating of flame-retardant Makrolon® LED 2245 plaques with the single-layer coating material PHC 587 which comprises 1.5% by weight of Gasil HP 230 matting agent

Substrate: LED 2245/C4 plaque, as described in A)

Coating material: 1.5 g of Gasil HP 230 are stirred into 500 g of PHC 587 coating material. A filter with pore size from 3 to 5 μm is then used for filtration.

Application of coating material: By analogy with example 6.

The results are shown in summary in table 1.

TABLE 1

| | | | PHC 587 + | PHC 587 + | PHC 587 + |
|---|---|---|---|---|---|
| | Substrate | PHC 587 | 0.4% Gasil | 0.75% Gasil | 1.5% Gasil |
| Fire class by | LED 2245/C4 | Ex. 6 | Ex. 7 | Ex. 8 | Ex. 9 |
| analogy with UL 94 | | | | | |
| Number of V-0 | 7 | 15 | 16 | 18 | 19 |
| specimens | | | | | |
| Number of V-1 | 0 | 1 | 0 | 1 | 1 |
| specimens | | | | | |
| Number of V-2 | 3 | 4 | 4 | 1 | 0 |
| specimens | | | | | |
| Transmittance/% | 90.0 | 91.3 | 91.1 | 91.3 | 90.8 |
| Haze/% | 1.4 | 1.0 | 1.8 | 2.5 | 4.6 |
| Steel wool test | scratches | no scratches | no scratches | no scratches | no scratches |

Fire behavior for examples 6 to 9 were determined on 20 test specimens in accordance with UL 94, and in the case of the substrate on 10 test specimens.

The results can be interpreted as follows:
Scratch resistance: Unlike the uncoated substrate which is scratched severely by steel wool, all of the coated substrates pass the steel wool test without difficulty.
Haze: As expected, increasing haze values are determined as the amount of Gasil HP 230 increases.
Flame retardancy (FR) values (V-0, V-1, V-2): Surprisingly, markedly improved flame retardancy results are determined as the amount of Gasil HP 230 matting agent increases (no V-2 for 1.5% of Gasil HP 230).

### Example 10

Coating of flame-retardant Makrolon® LED 2245 plaques with the single-layer coating material PHC 587 which comprises 2.0% by weight of Gasil HP 230 matting agent

Substrate: Makrolon® LED 2245/C4 plaque, as described in A)

Coating material: 2.0 g of Gasil HP 230 are stirred into 500 g of PHC 587 coating material. A filter with pore size from 3 to 5 μm is then used for filtration.

Application of coating material: By analogy with example 6.

Results: After coating, an irregular surface with markedly increased roughness is determined. Optical microscopy revealed that these defects were caused by aggregations of particles.

1-11. (canceled)

12. A coated item comprising a) a substrate with a transmittance of at least 88% (measured in accordance with ASTM E 1348 at 3 mm layer thickness and wavelength 550 nm) comprising a flame-retardant thermoplastic polymer and b) on the substrate, a scratch-resistant coating (K) comprising silica microparticles, where the amount of silica microparticles present, based on the solids content of the scratch-resistant coating (K), is from 0.2 to 1.8% by weight.

13. The coated item as claimed in claim 12, where the transmittance of the substrate is >89%.

14. The coated item as claimed in claim 12, wherein the substrate comprises a flame-retardant polycarbonate or a flame-retardant polycarbonate mixture with MVR greater than or greater than or equal to 9 (for 300° C. and 1.2 kg in accordance with ISO 1133).

15. The coated item as claimed in claim 14, wherein the substrate comprises a flame-retardant polycarbonate or a flame-retardant polycarbonate mixture with MVR greater than or greater than or equal to 20.

16. The coated item as claimed in claim 12, where the flame retardant is one selected from at least one of the group consisting of alkali-metal or alkaline-earth-metal salts of aliphatic/aromatic sulfonic-acid, sulfonamide, sulfonimide derivatives and phosphorus-containing flame retardants.

17. The coated item as claimed in claim 12, where the flame retardant is one selected from at least one of the group consisting of sodium nonafluoro-1-butanesulfonate, potassium nonafluoro-1-butanesulfonate, sodium diphenyl sulfone sulfonate and potassium diphenyl sulfone sulfonate.

18. The coated item as claimed in claim 12, wherein the average particle diameter of the silica microparticles is from 2 to 15 μm.

19. The coated item as claimed in claim 12, wherein the substrate comprises a sheet, panel, or foil.

20. The coated item as claimed in claim 12, where the silica-containing scratch-resistant coating is a coating obtained from a heat-curable hybrid coating material.

21. A method for the production of a flat screen element or of a glazing comprising utilizing the coated item as claimed in claim 12.

22. A flat screen element or a glazing comprising the coated item as claimed in claim 12.
